(19) United States
(12) Patent Application Publication
(10) Pub. No.: US 2005/0140272 A1
(43) Pub. Date: Jun. 30, 2005

(54) Method of producing an electroluminescence phosphor

(75) Inventor: Masashi Shirata, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: FUJI PHOTO FILM CO., LTD., Minami-ashigara-shi (JP)

(21) Appl. No.: 11/016,953

(22) Filed: Dec. 21, 2004

(30) Foreign Application Priority Data
Dec. 24, 2003 (JP) 2003-428309

(51) Int. Cl. H01J 1/62

(52) U.S. Cl. 313/503

(57) ABSTRACT

A method of producing an electroluminescence phosphor, which contains the steps of: mixing a phosphor matrix, a flux, an activator, and a particle diameter-controlling additive that does not enter into a crystal lattice of the phosphor matrix, to give a mixture; and baking the mixture, to produce the electroluminescence phosphor, the method containing the step of: adding an acidic or alkaline solution, to remove the particle diameter-controlling additive from the phosphor; an electroluminescence phosphor, which is produced by the method; and an electroluminescence device, which contains the electroluminescence phosphor.

### FIELD OF THE INVENTION

The present invention relates to an electroluminescence (EL) phosphor powder having high luminance and long life; to an electroluminescence device with a light-emitting layer obtained by dispersing and applying the electroluminescence powder particles, and to a method of producing these.

### BACKGROUND OF THE INVENTION

An electroluminescence phosphor is a phosphor that emits light when excited by electric power, for which known are a dispersion-type EL (electroluminescence) device where phosphor powder is sandwiched between electrodes, and a thin film-type EL device. Generally, a dispersion-type EL phosphor device is so designed that a dispersion of phosphor powder in a binder having a high dielectric constant is sandwiched between two electrodes at least one of which is transparent, and this emits light when an alternating current is applied between the two electrodes. The light-emitting device that comprises such an electroluminescence phosphor powder, has many advantages in that it may be thinned to have a thickness of several millimeters (mm) or less and, since it is a surface-emitting device, it does not generate heat and its light emission efficiency is high. Therefore, the EL devices are expected to have many applications for traffic sings, lighting equipment for various interiors and exteriors, light sources for flat panel displays such as liquid-crystalline displays, light sources for lighting equipment for large-area advertising pillars, and the like.

The dispersion-type EL device has the advantages that, since it is not produced through a high-temperature process, it may therefore be used to produce flexible devices provided with a substrate made of plastic; it can be produced at low cost in a relatively simple process using no vacuum apparatus; and also, the luminous color of the device can be easily controlled with a plural kinds of phosphor particles differing in luminous color to be mixed in; and therefore, the dispersion type is currently applied to display devices and back lights of, for example, LEDs. However, because this dispersion type has low luminance and efficiency, and it also requires voltage as high as 100 V or more to emit light of high luminance, it is limited in the range of applications, and as such, there is need for further improved luminance and luminous efficacy.

Measures used to drop luminance and emission voltage include a widely known method in which the layer thickness of the phosphor layer is decreased, to thereby heighten the electric field in the phosphor layer. However, generally, if it is intended to limit the layer thickness to 60 μm or less, when the phosphor particles have a particle diameter of 20 μm or more, irregularities are formed when it is intended to apply a smooth phosphor layer, causing deteriorated resistance to voltage, reduced life, and uneven emission in the resultant device.

On the other hand, an electroluminescence phosphor powder widely known in the art is comprised of zinc sulfide as the matrix thereof, along with an activator such as copper (metal ion serving as a light-emitting center) and a co-activator such as chlorine or chloride added thereto. However, the light-emitting device that utilizes the phosphor powder has some drawbacks in that its luminance (brightness) is low and its light emission life is short, as compared with those of light-emitting devices based on any other principle. Therefore, various improvements have heretofore been made on the phosphor powder.

Regarding the structure of conventional phosphor particles that enable light emission of high luminance, JP-A-8-183954 (“JP-A” means unexamined published Japanese patent application), pp. 3 to 4, FIG. 1, discloses zinc sulfide phosphor particles that are characterized in that they have plane-like stacking fault or defect of high density uniformly and everywhere in each particle and the average spacing of the stacking defect is from 0.2 to 10 nm. JP-A-8-183954 describes as follows: In the particles, copper ions serving as an activator are localized in the stacking defect of the matrix crystal of zinc sulfide, and they form a conductive layer. Accordingly, when a voltage is applied thereto, the particles may release electrons and holes at high efficiency, and therefore enable light emission of high luminance.

These electroluminescence particles are usually amorphous, with a particle size of 20 μm or more. For example, as shown in JP-A-7-62342, raw material zinc sulfide particles, together with an agent called a flux, are subjected to a first baking (firing), performed at as very high a temperature as 1000 to 1300° C., to grow these particles, and then to a second baking, performed at 500 to 1000° C., to thereby obtain electroluminescence zinc sulfide particles having high luminous efficacy, in current main methods. There are descriptions concerning this production method in, for example, JP-A-7-62342 and JP-A-6-330035.

However, the phosphor has the problem that the operation voltage of an electroluminescence device using the phosphor is high, which increases power consumption. Specifically, uniform application of a light-emitting layer, in which the phosphor is dispersed in an organic binder, requires the light-emitting layer to have a layer thickness as thick as about 60 μm, with the result that the voltage to be applied is not applied efficiently. As a result of this, the electric field intensity applied to the phosphor becomes small, leading to insufficient luminance. Therefore, the operation voltage is increased to obtain necessary luminance. Measures to raise luminance or to drop operation voltage include a widely known method in which the layer thickness of a phosphor layer is decreased, to raise the electric field in the phosphor layer. However, generally, when intending to limit the layer thickness to 60 μm or less, when the diameter of phosphor particles is 20 μm or more, the coated phosphor layer is not made smooth, resulting in the formation of irregularities, causing a reduction in voltage resistance and life, and non-uniform emission.

Measures taken for this include use of a highly luminous phosphor having a small particle diameter, thereby the layer thickness of the light-emitting layer can be decreased, and the operating voltage of the device can be hence dropped. It is to be noted that, if the particle diameter is large and luminance is sufficiently high, the operation voltage can be decreased. However, this is not easily realized. There are, for example, usual methods, including a method of dropping the baking temperature, a method of shorting the baking time, and a method of reducing the amount of a flux, to obtain phosphors having a small particle diameter. However, luminance is dropped in all of these methods, and these methods are not practical. The flux, in particular, functions also as a co-activator, and therefore reducing the amount of flux results in an insufficient amount of a co-activator, bringing about reduced luminance.

Further, other means taken to obtain phosphors having a small particle diameter include a known method in which a particle growth inhibitor is mixed in, to carry out baking, as described in JP-A-11-193378. This method, however, has the problem that it is difficult to remove the particle growth inhibitor after baking. Specifically, it is disclosed that, to remove the particle growth inhibitor, a mixture containing the particle growth inhibitor is separated mechanically by ultrasonic vibration, and is then classified by the difference in sedimentation speed in water or screened by a screen. In such a method, the time period required for classification is long; the difference in particle diameter between the phosphor particle and the particle growth inhibitor is insufficient to screen the two differentially; and the particle growth inhibitor is strongly adsorbed onto the surface of the phosphor particles. Therefore, in this method, not only is the process complicated, it is also difficult to remove the particle growth inhibitor completely.

### SUMMARY OF THE INVENTION

The present invention resides in a method of producing an electroluminescence phosphor, which comprises the steps of:
mixing a phosphor matrix, a flux, an activator, and a particle diameter-controlling additive that does not enter into a crystal lattice of the phosphor matrix, to give a mixture; and
baking the mixture, to produce the electroluminescence phosphor, said method comprising the step of: adding an acidic or alkaline solution, to remove the particle diameter-controlling additive from the phosphor.

Further, the present invention resides in an electroluminescence phosphor, which is produced by the above method, wherein the phosphor matrix has zinc sulfide, and wherein the phosphor has an average circle equivalent diameter of less than 20 μm.

Further, the present invention resides in an electroluminescence device, which comprises the above electroluminescence phosphor.

Other and further features and advantages of the invention will appear more fully from the following description.

### DETAILED DESCRIPTION OF THE INVENTION

According to the present invention, there are provided the following means:

(1) A method of producing an electroluminescence phosphor, comprising the steps of:
mixing a phosphor matrix, a flux, an activator, and a particle diameter-controlling additive that does not enter into the crystal lattice of the phosphor matrix, to give a mixture; and
baking the mixture, to produce the electroluminescence phosphor,
said method comprising a step of: adding an acidic or alkaline solution, to remove the particle diameter-controlling additive from the phosphor;

(2) The method of producing an electroluminescence phosphor according to the above item (1), wherein a residual rate of the particle diameter-controlling additive is 5% or less;

(3) The method of producing an electroluminescence phosphor according to the above item (1) or (2), wherein the particle diameter-controlling additive has a particle diameter of 0.005 to 0.5 μm;

(4) The method of producing an electroluminescence phosphor according to any one of the above items (1) to (3), wherein the particle diameter-controlling additive is a compound containing at least one of alkali earth metal oxides;

(5) The method of producing an electroluminescence phosphor according to any one of the above items (1) to (4), wherein the particle diameter-controlling additive is magnesium oxide;

(6) An electroluminescence phosphor, which is produced by the method of producing an electroluminescence phosphor according to any one of the above items (1) to (5), wherein the phosphor matrix has zinc sulfide, and wherein the phosphor has an average circle equivalent diameter (an average of diameter of circles each having an area equal to an individual particle) of less than 20 μm;

(7) The electroluminescence phosphor according to the above item (6), wherein a coefficient of variation in the average circle equivalent diameter among the phosphors (particles of the phosphor) is less than 40%;

(8) The electroluminescence phosphor according to the above item (6), which contains, as an additive, a compound containing at least one element selected from the group consisting of Au, Sb, Bi and Cs; and

(9) An electroluminescence device, comprising the electroluminescence phosphor according to the above item (6), (7) or (8).

The present invention is described in detail below.

The matrix (host material) of the phosphor particle, which matrix can be preferably used in the present invention, is specifically a semiconductor fine-particle, for example, of a II-VI compound that is composed of an element of the II group and an element of the VI group, or a III-V compound that is composed of an element of the III group and an element of the V group, and these elements may be selected arbitrarily, according to a target luminescence wavelength region. Herein, the II to VI groups are those in the periodic table of elements. Examples of these compounds include CdS, CdSe, CdTe, ZnS, ZnSe, ZnTe, CaS, SrS, GaP, and GaAs. Among these, ZnS, CdS and CaS can be preferably used, and ZnS can be particularly preferably used.

The phosphor fine-particles in the present invention may be formed by the baking method (solid phase method) which is widely used in the field of the art. In the case of, for example, zinc sulfide, a fine-particle powder (usually called as a raw powder) 10 nm to 50 nm in size is formed by a liquid phase method, and it is used as primary particles, that is, the matrix. Zinc sulfide includes two crystalline systems, namely, a high-temperature stable-type hexagonal system and a low-temperature stable-type cubic system. Any of these systems may be used in the present invention, and a mixture of these systems may be used. For example, the zinc sulfide powder is baked, together with an impurity, which is called as an activator and, if necessary, a co-activator; a flux, and a particle diameter-controlling additive, at a high temperature ranging from 900 to 1300° C. in a crucible for 30 minutes to 10 hours, to obtain particles. This baking method makes use of substantial liquid phase crystal growth, owing to melting of the flux in the high-temperature baking. During baking, if the molten flux fills up space or gap among matrix particles, it results in increase of the opportunities for the matrix particles being in contact each other, thereby the particles are grown in a state similar to a liquid phase. Contrary to the above, when the particle diameter-controlling additive fills up the space among matrix particles, the opportunities are decreased for the matrix particles to be brought in contact each other, and particle growth is suppressed. Therefore, although the amounts of the activator and the flux are proper and the baking conditions are satisfactory for the growth of crystals, the crystal growth of the matrix can be suppressed and a phosphor having high luminance and small particle diameter can be, therefore, obtained.

Further, in the present invention, an intermediate phosphor powder obtained in the above baking is washed with ion exchange water, to remove the activator, the co-activator and the flux in excess; and then, the resultant particle powder is washed with an acidic or alkaline solution, to remove the particle diameter-controlling additive. In the present invention, the acidic solution means a solution having a pH of 6 or less, and the alkaline solution means a solution having a pH of 8 or more. There is no particular limitation on the conditions of washing using an acidic or alkaline solution, as long as the particle diameter-controlling additive can be removed and the phosphor is not adversely affected. The following conditions are preferable: washing temperature of 10° C. or more and 60° C. or less, washing time of 15 minutes or less per one washing, and the number of washings 10 times or less. With regard to the solutions to be used for said washing, it is preferable that an acidic solution has a pH of 3 or less and an alkaline solution has a pH of 9 or more. As to a particularly effective type of a solution among acidic solutions, an aqueous hydrochloric acid solution is preferable. As to the concentration, for example, of hydrochloric acid, if the concentration is too high, it is undesirable because the solution may dissolve the surface of the phosphor at the same time. If the concentration is, on the contrary, too low, the washing or detergent effect is small and the particle diameter-controlling additive may not be removed sufficiently. The concentration of acid, e.g. hydrochloric acid, or base is preferably 0.05 to 5 mol/l, more preferably 0.1 to 3 mol/l, and particularly preferably 0.5 to 2 mol/l.

Further, in the present invention, the residual rate in terms of mass ratio of the particle diameter-controlling additive after washing in the above conditions is preferably 5% or less, more preferably 3% or less, and still more preferably 1.5% or less. If the particle diameter-controlling additive is left and remained in a too large amount, it is undesirable because EL luminance may be dropped. Herein, the residual rate can be determined by quantitatively measuring the amounts of the particle diameter-controlling additive by ICP before and after washing.

Plane-like stacking faults (twin crystal structure) caused naturally are present inside of the intermediate phosphor particles obtained by baking. The density of the stacking faults can be largely increased, without breaking particles by further applying a certain level of impact. Examples of known methods of applying impact include a method in which the intermediate phosphor particles are brought into contact each other and mixed them; a method in which sphere bodies, such as alumina, are mixed (e.g. with a ball mill) in the intermediate phosphor particles, to mix these with each other; and a method in which the particles are accelerated, to collide these particles among them. In the case of, particularly, zinc sulfide, two crystal systems, namely, a cubic crystal system and a hexagonal crystal system exist. In the former system, the closest atomic plane ((111) plane) forms a three-layer structure, e.g. ABCABC . . . , and in the latter system, the closest atomic plane perpendicular to the c-axis forms a two-layer structure, e.g. ABAB . . . . Because of this, when impact is applied to zinc sulfide crystals by a ball mill or the like, slippage of the closest atomic plane takes place in the cubic crystal system. If the C-plane comes out, the cubic system is partially transformed to an ABAB hexagonal system, causing edge-like dislocation, and also, there may be the case where the AB planes are reversed to each other to produce twin crystals. Generally, impurities in crystals are concentrated on lattice defect regions. Therefore, when zinc sulfide having stacking faults is heated to diffuse an activator such as copper sulfide, the activator precipitates at stacking faults. Because the boundary between the region where the activator precipitates and the matrix zinc sulfide becomes the center of electroluminescence phosphor (luminophor), it is also preferable in the present invention that the density of stacking faults is high in improvement in luminance.

Then, the resultant intermediate phosphor powder is subjected to a second baking. The second baking is carried out, for example, by heating (annealing) at 500 to 800° C., which is a temperature lower than that in the first baking, for 3.0 minutes to 3 hours, which is a time period shorter than that in the first baking. The activator can be thereby precipitated intensively at the stacking faults.

Thereafter, the intermediate phosphor is etched using an acid such as hydrochloric acid, to remove a metal oxide attached to the surface thereof, and further, copper sulfide attached to the surface thereof is washed by KCN or the like, to be removed. Then, the resultant phosphor is dried, to give an electroluminescence phosphor.

The particle diameter-controlling additive for use in the present invention decreases the opportunities of the matrix particles being in contact among them. Therefore, if the particle diameter of the additive is too large, the effect of controlling particle diameter is reduced and it is difficult to form small-size particle. On the other hand, if the particle diameter of the additive is too small, it is undesirable because the additive itself grows and coarsened during baking. It is necessary that the particle diameter-controlling additive for use in the present invention be prevented from entering into the crystal lattice of the phosphor matrix. Herein, the term “entering into the crystal lattice of the phosphor matrix” means solid solution at atom order or precipitation at grain boundary. If the particle diameter-controlling additive enters into the crystal lattice of the phosphor matrix, it is assumed that the particle diameter-controlling additive becomes the quenching center or the resultant particles are colored.

The particle diameter of the particle diameter-controlling additive for use in the present invention is generally 0.005 to 0.5 μm, and preferably 0.01 to 0.2 μm. Further, there is a preferable range of the ratio by mass of the additive to the matrix, and the mass ratio is preferably 2 to 80 mass %. If the mass ratio is too small, the amount of the additive is insufficient so that the effect of controlling particle diameters may not be exhibited and a reduction in particle size may not be attained. If the mass ratio is too large, the additive is attached to and left on the surface of the phosphor and may not be separated from the surface, resulting in reduced luminance.

Any material may be used as the particle diameter-controlling additive for use in the present invention, without any particular limitation insofar, as it does not react with the phosphor matrix in the baking conditions under which a phosphor having a target chemical composition is obtained and it is dissolved in an acidic or alkaline solution. As such a particle diameter-controlling additive, any of alkali metal oxides, alkali earth metal oxides, and transition metal oxides is most preferable. Among these materials, magnesium oxide, calcium oxide, zinc oxide and the like are particularly preferable.

Further, when the baking temperature is too high, there is the case where the particle diameter-controlling additive is decomposed or reacts with the matrix, and the baking temperature is therefore preferably 900 to 1300° C. as mentioned above.

The activator, the co-activator and the flux, each of which can be used in the present invention, are not particular limited, and general materials well-known in the fields of the art may be used. The matrix may be applied to the production of phosphors having any composition, such as a cathode ray tube and a fluorescence or phosphorescence display tube, besides a phosphor for electroluminescence devices, insofar as it does not react with the particle diameter-controlling additive and the additive is dissolved in an acidic or alkaline solution.

Further, the electroluminescence phosphor obtained according to the present invention has an average circle equivalent diameter of generally less than 20 μm (preferably 3 to 19 μm), and the coefficient of variation in particle size among particles of the electroluminescence phosphor is generally less than 40% (preferably 15 to 38%). Herein, the circle equivalent diameter means the diameter of a circle obtained by approximating the projected area of an individual particle observed by an electron microscope. The coefficient of variation means a coefficient of variation (the value S/d obtained by dividing a standard deviation S by a circle equivalent diameter d) calculated statistically. These characteristics of the electroluminescence phosphor make it possible to develop a thinner layer and more uniform light-emitting layer in the electroluminescence device.

Further, in the EL phosphor of the present invention, it is preferable that at least one of Au, Sb, Bi and Cs is added as an additive in a form of compound containing any of these elements. In particular, it is preferable that Au is added for activation. For example, emission life of the EL phosphor can be remarkably improved, by adding these elements, since CuₓS crystal, which is an electron-generating source of the EL phosphor, can be prevented from deteriorating. In particular, this effect is remarkable in an EL phosphor of a small-size particle. The addition amount of the additive, such as an Au-containing compound, is preferably in a range of 1×10⁻⁵ to 1×10⁻³ mol, more preferably 5×10⁻⁵ to 5×10⁻⁴ mol, per mol of the matrix, such as ZnS.

The phosphor obtained according to the present invention preferably has, on the surface thereof, a non-light-emitting shell layer. The formation of the shell layer is preferably conducted by a chemical method following the preparation of the semiconductor fine-particle, which will be a core of the phosphor. The thickness of the shell layers to be formed is preferably 0.1 μm or more, more preferably 0.1 μm or more but 1.0 μm or less.

The non-light-emitting shell layer can be made of an oxide, nitride, or oxide/nitride, or a substance that has the same composition as those formed on the matrix of the phosphor but contains no luminescence center. The shell layer can also be formed by epitaxially growing, on the matrix of the phosphor, a substance which has a different composition from that of the matrix.

Examples of applicable methods of forming the non-light-emitting shell layer include a vapor phase method, such as a method of combination of fluidized oil surface deposition with an electron beam, sputtering or resistance-heating method, a laser ablation method, or a CVD (chemical vapor deposition) method, a plasma method; a liquid phase method, such as a double decomposition method, a sol-gel method, an ultrasonic chemical method, a method by thermal decomposition reaction of a precursor, a reversed micelle method, a combination method of any of these methods with high temperature baking, a urea melting method, and a freeze-drying method, and a spray thermal decomposition method.

Particularly, the urea melting method and the spray thermal decomposition method, which can be preferably used for the formation of particles of the phosphor, are also preferable for the synthesis of the non-light-emitting shell layer.

For example, in the case of forming a non-light-emitting shell layer on the surface of the zinc sulfide phosphor particle, the zinc sulfide phosphor is added in a urea solution in which a metal salt that would be a material of the non-light-emitting shell layer is dissolved and melted. Because zinc sulfide is insoluble in urea, the temperature of the solution is raised in the same manner as in the case of forming particles, to obtain a solid in which the zinc sulfide phosphor and the non-light-emitting shell layer material are uniformly dispersed in a resin derived from urea. This solid is pulverized, and then baked with heat-decomposing the resin in an electric furnace. The baking atmosphere is selected from inert atmosphere, acidic atmosphere, reducing atmosphere, ammonia atmosphere and vacuum atmosphere, thereby zinc sulfide phosphor particle having a non-light-emitting shell layer composed of an oxide, sulfide or nitride on the surface can be synthesized.

Alternately, for example, in the case of forming a non-light-emitting shell layer on the surface of the zinc sulfide phosphor particle by a spray thermal decomposition method, the zinc sulfide phosphor is added in a solution in which a metal salt that would be a material of the non-light-emitting shell layer is dissolved. This solution is atomized, and thermally decomposed, to form the non-light-emitting shell layer on the surface of the zinc sulfide phosphor particle. By appropriately selecting the atmosphere of the thermal decomposition and the atmosphere of an additional baking, zinc sulfide phosphor particle having a non-light-emitting shell layer composed of an oxide, sulfide or nitride on the surface can be synthesized.

The phosphor obtained according to the present invention is preferably used in an electroluminescence device. The electroluminescence device preferably has a basic structure, in which a light-emitting layer is sandwiched between a pair of electrodes disposed opposite to each other, at least one of these electrodes being transparent, and in which a dielectric layer is adjacently provided with between the light-emitting layer and one or each electrode.

The light-emitting layer can be composed of one in which the phosphor is dispersed in a binder. As the binder, use can be made, for example, of a polymer having a relatively high dielectric constant, e.g. a cyanoethyl cellulose-series resin; polyethylene, polypropylene, or polystyrene-series resins, silicone resins, epoxy resins, resins of a vinylidene fluoride. The dielectric constant of the dielectric layer can be adjusted by properly mixing, for example, BaTiO₃ or SrTiO₃ fine-particle having a high dielectric constant, into such a resin.

The dielectric layer may be made of any material that has a high dielectric constant, high insulating property, and a high dielectric breakdown voltage. The material can be selected from metal oxides and metal nitrides. Examples thereof include TiO₂, BaTiO₃, SrTiO₃, PbTiO₃, KNbO₃, PbNbO₃, Ta₂O₃, BaTa₂O₆, LiTaO₃, Y₂O₃, Al₂O₃, ZrO₂, AlON, and ZnS. Such a material may be provided as a homogeneous film or may be used as a film having grain structure.

The light-emitting layer and the dielectric layer can be provided, according to a coating method, such as a spin coating method, a dip coating method, a bar coating method, a screen printing method, or a spray coating method.

The method for preparing the dielectric film may be a gas-phase process such as sputtering or vacuum evaporation. In this case, the thickness of the film is generally from 100 nm to 1,000 nm.

As the transparent electrode in the above-described electroluminescence device, any of generally used transparent electrode materials are arbitrarily used. Examples of the transparent electrode material include oxides such as indium-doped tin oxide, antimony-doped tin oxide, and zinc-doped tin oxide; multi-layer structure films of silver thin film sandwiched between high-refractive-index layers; and n-conjugated polymers, such as polyanilines and polypyrroles.

It is also preferable to arrange a tandem-type, grid-type, or the like type metal fine-line on the transparent electrode, thereby to improve current-carrying performance.

The back electrode, which is present on the side from which light is not taken out, may be made of any material that has electric conductivity. The material is appropriately selected from metals such as gold, silver, platinum, copper, iron and aluminum; graphite, and other materials, considering the form of the device to be produced, the temperature in producing steps, and other factors. A transparent electrode such as an ITO electrode may be used, as long as it has electric conductivity.

The electroluminescence device according to the present invention is preferably worked, at end of its production, with a suitable sealing material, so as to exclude effect of humidity from external environment. In the case that the substrate itself of the device has sufficient shielding property, a shielding sheet (to seal, for example, moisture or oxygen) may be put over the produced device and the surrounding of the device may be sealed with a hardening material such as an epoxy resin.

The material for the above shielding sheet may be selected from glass, metal, plastic film, or the like, according to the application.

The above electroluminescence device preferably contains, in the light-emitting layer, the phosphor which is in contact with a dielectric substance. The total film thickness of the light-emitting layer that contains the phosphor and an insulating layer that contains an inorganic dielectric substance made to be adjacent to the light-emitting layer according to the need, is preferably 3 to 10 times the average particle size of the phosphor. As to the contact between the phosphor and the dielectric substance, it is preferable that the phosphor is coated with the non-light-emitting shell layer completely or partially. However, the phosphor may be simply in contact with the dielectric substance.

For example, electrons are supplied from the interface level formed by the contact between the phosphor and the dielectric substance. The electrons introduced into the inside of the phosphor are accelerated in a strong electric field, to become hot electrons. These accelerated electrons collide with the light-emission center which is doped in the phosphor crystal, to excite the emission center, thereby highly luminous emission of light can be obtained.

The lower limit of the device thickness is the size of the phosphor (phosphor particle). However, in order to keep the smoothness of the device, it is preferable that the thickness of the device is 3 to 10 times larger than the size of the phosphor. Herein the thickness of the device referred to means the total thickness of a light-emitting layer containing the phosphor sandwiched between electrodes and an inorganic dielectric layer that is close or adjacent to the light-emitting layer.

Further, the dielectric layer is preferably formed by coating in such a manner to cover a part of the upper portion of the phosphor, i.e. a portion of the dielectric layer may extend into a portion of the light-emitting layer, to thereby exhibit the effect of increasing contact points and improving the smoothness of the device surface.

Further, the dielectric substance that can be used in the above electroluminescence device may be in the form of a thin film crystal layer, in the form of particles, or in the form of combination thereof. The dielectric layer containing the dielectric substance may be formed on one side of the light-emitting layer, or it is preferably formed on the both sides of the light-emitting layer. In the case of the thin film crystal layer, the film may be a thin film formed on a substrate by a gas-phase process such as sputtering, or a sol-gel film made by using an alkoxide of Ba, Sr or the like. In the case of the particle form, it is preferable that the particles are sufficiently smaller than the phosphor particles. Specifically, the size thereof is preferably from ⅓ to 1/100 of the size of the phosphor, more preferably from ⅕ to 1/50 thereof.

Further, when the electroluminescence device which preferably utilizes the electroluminescence phosphor produced according to the production method of the present invention, has a thin thickness and is excited in a high electric field, it is important that the distances between the electrodes that sandwich the electroluminescence device are uniform. Specifically, when the dispersion of the distance between the electrodes is defined as a center line average roughness Ra, the roughness Ra is preferably (d×⅛) μm or less, more preferably (d×1/10) μm or less, in which d (μm) is the thickness of the light-emitting layer.

The electroluminescence device which preferably utilizes the electroluminescence phosphor obtained according to the present invention, is not particularly limited in the application thereof. However, taking the application as a light source into consideration, preferably the luminescent color is a white color. As the method of outputting a white luminescent color, use can be preferably made, for example, of a method of forming the light-emitting layer of the electroluminescence device with a mixture of two or more kinds of phosphors having two or more colors of light to be emitted (e.g. a combination of blue, green and red, and a combination of bluish green and orange).

It is also preferable to use a method of making into a white color, according to the steps of: emitting a short-wavelength light such as blue; and wavelength-converting a part of the emission to green or red.

Further, in the constitution of the electroluminescence device which utilizes the electroluminescence phosphor produced according to the production method of the present invention, a substrate, a transparent electrode, a back electrode, any of various protective layers, a filter, a light-scattering reflecting layer, and the like may be provided, if necessary. As the substrate in particular, a flexible transparent resin sheet may also be used, in addition to a glass substrate or a ceramic substrate.

The phosphor particle which can be obtained according to the present invention is preferably combined properly with an electroluminescence device structure as mentioned above, thereby a highly luminous and highly efficient electroluminescence device can be provided.

According to the present invention, the low luminance problem of a conventional dispersion-type electroluminescence device can be improved. Specifically, phosphor particles contained in a dispersion-type electroluminescence device are made to have a smaller particle diameter, and further, they-are mono-dispersed, thereby a uniform and thin-layer electroluminescence device can be developed, and the strength of the electric field applied to the device can be heightened. Namely, the present invention can provide a particle dispersion-type electroluminescence device having high luminance; an electroluminescence phosphor particle that is preferably used in this device; and a preferable method of producing the device or the particle.

According to the production method of the present invention, an electroluminescence phosphor having high luminance and small particle diameter can be produced. Since the electroluminescence phosphor of the present invention has high luminance and small particle diameter, it can be preferably used for electroluminescence devices and can make uniform the light-emitting layer of the device and make the layer thickness thin. Further, the electroluminescence device of the present invention has a long life. Further, the electroluminescence device of the present invention also has such excellent effects that it emits light with high luminance and high efficiency, and specifically works on a low voltage.

The present invention will be described in more detail based on examples given below, but the invention is not meant to be limited by these.

### EXAMPLES

### Example 1

To a dry powder of 25 g of a zinc sulfide (ZnS) particle powder of average particle diameter 50 nm and copper sulfate (CuSO₄) added in an amount of 0.07 mol % to the ZnS, added were 5 g of an ammonium chloride (NH₄Cl) powder as a flux and 5 g of a magnesium oxide (MgO) powder of average particle diameter 0.05 μm as a particle diameter-controlling additive, to mix these. The resultant mixture was placed in an alumina crucible, baked at 1,250° C. for one hour, followed by quenching. Then, the resultant powder was taken out, and washed with deionized water several times and further with 0.5-mol/l hydrochloric acid several times. Then, the thus-washed powder was subjected to sedimentation, followed by removing the supernatant and drying, to give an intermediate phosphor. Then, the intermediate phosphor was pulverized and dispersed using a ball mill. Further, thereto were added 5 g of ZnCl₂ and copper sulfate in an amount of 0.10 mol % to the ZnS. Then, 1 g of MgCl₂ was added to the resultant mixture, to produce a dry powder, which was placed again in an alumina crucible and baked at 700° C. for 2 hours. At that time, the baking was carried out under flowing 10% hydrogen sulfide gas as the atmosphere.

The particles after baking were pulverized again, and dispersed in 40° C. water and subjected to sedimentation, followed by removing the supernatant of the dispersion, and then unnecessary salts were removed therefrom, followed by drying, to give a phosphor. Further, a 10% KCN solution was heated to 70° C., which was used to remove Cu ions and the like from the surface of the resultant phosphor.

Using the thus-obtained phosphor, an electroluminescence device was produced in the following manner.

The thus-obtained phosphor was dispersed in a cyano resin solution of 30-mass % concentration. With the resultant solution, a glass substrate coated with ITO was coated, by screen-printing. The substrate was dried at 120° C. for one hour, using a hot air dryer, to form a phosphor layer on the substrate. Then, BaTiO₃ fine-particle of average particle size 0.5 μm was dispersed in a 30-mass % cyano resin solution, and the phosphor layer was then coated with the resultant solution by screen printing such that the thickness of the dielectric layer to be formed would be 10 μm, followed by drying at 120° C. for one hour using a hot air dryer. Further, the layer formed above was coated with carbon paste by screen printing such that the thickness of the layer to be formed would be about 50 μm, to form a backing electrode. Terminals for external connection were led from the aforementioned transparent electrode and backing electrode of the device by using silver paste, respectively, and then the resultant device was sandwiched between two moisture-proof sheets, followed by thermal compression (thermocompression bonding).

### Example 2

A phosphor was produced in the same manner as in Example 1, except that calcium oxide of particle diameter 0.05 μm was added in place of the magnesium oxide, as the particle diameter-controlling additive. Except for using

the thus-obtained phosphor, an electroluminescence device was prepared in the same manner as in Example 1.

### Example 3

A phosphor was produced in the same manner as in Example 1, except that 4 g of zinc oxide of particle diameter 0.07 μm was added in place of the magnesium oxide, as the particle diameter-controlling additive, and that the washing after baking was carried out using a 1-mol/l aqueous sodium hydroxide solution in place of the 0.5-25 mol/l hydrochloric acid. Except for using the thus-obtained phosphor, an electroluminescence device was prepared in the same manner as in Example 1.

### Comparative Example 1

A phosphor was produced in the same manner as in Example 1, except that 25 g of α-alumina of particle diameter 0.05 μm was added in place of the magnesium oxide, as the particle diameter-controlling additive, and that the washing after baking was carried out using deionized water in place of the 0.5-mol/l hydrochloric acid. Except for using the thus-obtained phosphor, an electroluminescence device was prepared in the same manner as in Example 1.

(Evaluation)

With respect to each phosphor obtained in the above Examples 1 to 3 and Comparative Example 1, the average circle equivalent diameter (average in 500 particles observed by SEM), the residual rate (the masses before and after washing were compared by ICP) of the particle diameter-controlling additive in the intermediate phosphor after washing; and a reduction in voltage, which is designated as the difference from the voltage in Comparative Example 1 that is assumed to be a standard, when sinusoidal alternating voltage (400 Hz) was applied to give the same luminance, were measured. The results are shown in Table 1.

TABLE 1

| | | | | Residual rate | Average | |
|---|---|---|---|---|---|---|
| | | | | of the particle | circle | |
| | | | | diameter- | equivalent | |
| | Particle diameter-controlling additive | | | controlling | diameter | |
| | | Particle | | additive after | of the | Reduction |
| | | diameter | | washing | phosphor | in voltage |
| | Kind | (μm) | Washing method | (%) | (μm) | (V) |
| Example 1 | Magnesium | 0.05 | 0.5 mol/l | 0.5 | 12 | 13 |
| | oxide | | hydrochloric acid | | | |
| Example 2 | Calcium | 0.05 | 0.5 mol/l | 1.0 | 14 | 11 |
| | oxide | | hydrochloric acid | | | |
| Example 3 | Zinc oxide | 0.07 | 1.0 mol/l | 1.3 | 13 | 12 |
| | | | aqueous sodium | | | |
| | | | hydroxide solution | | | |
| Comparative | α-Alumina | 0.05 | Deionized water | 58 | 14 | Standard |
| example 1 | | | | | | |

As is apparent from the results shown in Table 1, it was found that there was no significant difference in the particle diameter among the phosphors (zinc sulfide) obtained even if any of the particle diameter-controlling additives was used. However, because α-alumina is not dissolved in hydrochloric acid and also in an aqueous sodium hydroxide solution (in an additional experimental test), α-alumina could be removed to some extent by washing, utilizing the difference of precipitation speed between α-alumina and zinc sulfide, but it was not completely removed. As a result, α-alumina left and unremoved absorbed emission of any light, and satisfactory luminance could not be obtained.

It was also found that, on the contrary, magnesium oxide and calcium oxide were dissolved in hydrochloric acid and zinc oxide was dissolved in an aqueous sodium hydroxide solution, and almost all of these oxides could be removed by washing. Therefore, the obtained luminance was quite high; specifically, the voltage required to obtain the same luminance could be remarkably reduced. It was found that when, particularly, magnesium oxide was used as the particle diameter-controlling additive, excellent results were obtained for the particle diameter of the resultant phosphor, and the luminance.

### Example 4

To high-purity zinc sulfide (average particle diameter 70 nm), were added copper sulfate in an amount of 0.05 mol % as an activator, ammonium chloride in an amount of 10.0 mol % and barium chloride in an amount of 0.5 mol % as co-activators, and magnesium oxide (average particle diameter 0.1 μm) in an amount of 20 mass % as a particle diameter-controlling additive, to mix these components. Then, the resultant mixture was baked at 1,200° C. for 3 hours in a hydrogen sulfide atmosphere. After baking, the resultant product was pulverized, washed with deionized water several times and further with 1.0-mol/l hydrochloric acid several times. Then, the thus-washed powder was subjected to sedimentation, followed by removing the supernatant and drying, to obtain an intermediate phosphor.

To the intermediate phosphor, were again added copper sulfate in an amount of 0.05 mol % and ammonium chloride in an amount of 2.0 mol %, to mix them. The mixture was baked at 750° C. for 2 hours in a nitrogen atmosphere. The baked product was pulverized again, dispersed in 40° C. H₂O and subjected to sedimentation, followed by removing the supernatant of the dispersion. Then, unnecessary salts were removed therefrom, followed by drying, to give a phosphor. Further, a 10% KCN solution was heated to 70° C., and using the solution, Cu ions and the like on the surface of the phosphor were removed.

Herein, the “mol %” and “mass %” means the respective percentage of a component to the above ZnS.

The thus-prepared phosphor was dispersed in cyanoethyl cellulose. The resultant dispersion was applied on an aluminum electrode by screen-printing, to form a light-emitting layer. Further, a transparent electrode was formed on the light-emitting layer, to prepare an electroluminescence device. Terminals for external connection were led from the aforementioned transparent electrode and backing electrode of the device by using silver paste, respectively, and then the device was sandwiched between two moisture-proof sheets, followed by thermal compression.

### Comparative Example 2

A phosphor was produced in the same manner as in Example 4, except that the washing after baking at 1,200° C. for 3 hours was carried out using deionized water in place of the 1.0-mol/l hydrochloric acid. Except for using the thus-obtained phosphor, an electroluminescence device was prepared in the same manner as in Example 4.

The products obtained in Example 4 and Comparative Example 2 were tested and evaluated in the same manner as in Example 1. The results obtained are shown in Table 2. The reduction in voltage is designated as the difference from the voltage in Comparative Example 2 that is assumed to be a standard.

TABLE 2

| | | | | Residual rate | Average | |
|---|---|---|---|---|---|---|
| | | | | of the particle | circle | |
| | | | | diameter- | equivalent | |
| | Particle diameter-controlling additive | | | controlling | diameter | |
| | | Particle | | additive after | of the | Reduction |
| | | diameter | | washing | phosphor | in voltage |
| | Kind | (μm) | Washing method | (%) | (μm) | (V) |
| Example 4 | Magnesium | 0.1 | 1.0 mol/l | 0.4 | 14 | 12 |
| | oxide | | hydrochloric acid | | | |
| Comparative | Magnesium | 0.1 | Deionized water | 39 | 14 | Standard |
| example 2 | oxide | | | | | |

As is apparent from the results shown in Table 2, it was understood that although the washing with deionized water failed to completely remove the particle diameter-controlling additive (magnesium oxide), the washing with hydrochloric acid succeeded in removing almost all of magnesium oxide and the voltage required to obtain the same luminance could be remarkably reduced.

### Example 5

A phosphor was produced in the same manner as in Example 1, except that the particle diameter of magnesium oxide to be added was changed to 0.005 μm. Except for using the thus-obtained phosphor, an electroluminescence device was prepared in the same manner as in Example 1.

### Example 6

A phosphor was produced in the same manner as in Example 1, except that the particle diameter of magnesium oxide to be added was changed to 0.1 μm. Except for using the thus-obtained phosphor, an electroluminescence device was prepared in the same manner as in Example 1.

### Example 7

A phosphor was produced in the same manner as in Example 1, except that the particle diameter of magnesium oxide to be added was changed to 0.2 μm. Except for using the thus-obtained phosphor, an electroluminescence device was prepared in the same manner as in Example 1.

### Example 8

A phosphor was produced in the same manner as in Example 1, except that the particle diameter of magnesium oxide to be added was changed to 0.5 μm. Except for using the thus-obtained phosphor, an electroluminescence device was prepared in the same manner as in Example 1.

### Example 9

A phosphor was produced in the same manner as in Example 1, except that the particle diameter of magnesium oxide to be added was changed to 1.0 μm. Except for using the thus-obtained phosphor, an electroluminescence device was prepared in the same manner as in Example 1.

### Example 10

A phosphor was produced in the same manner as in Example 1, except that the particle diameter of magnesium oxide to be added was changed to 0.002 μm. Except for using the thus-obtained phosphor, an electroluminescence device was prepared in the same manner as in Example 1.

The products obtained in Examples 5 to 10 were tested and evaluated in the same manner as in Example 1. The results obtained are shown in Table 3. The reduction in voltage is designated as the difference from the voltage in Comparative Example 1 that is assumed to be a standard.

TABLE 3

| | Particle | | | |
|---|---|---|---|---|
| | diameter | Residual rate | Average | |
| | of the | of the particle | circle | |
| | particle | diameter- | equivalent | |
| | diameter- | controlling | diameter | |
| | controlling | additive after | of the | Reduction |
| | additive | washing | phosphor | in voltage |
| | (μm) | (%) | (μm) | (V) |
| Example 1 | 0.05 | 0.5 | 12 | 13 |
| Example 5 | 0.005 | 0.2 | 19 | 10 |
| Example 6 | 0.1 | 0.8 | 14 | 12 |
| Example 7 | 0.2 | 1.0 | 15 | 11 |
| Example 8 | 0.5 | 1.0 | 21 | 10 |
| Example 9 | 1.0 | 4.5 | 22 | 8 |
| Example 10 | 0.002 | 1.0 | 23 | 7 |

As is apparent from Table 3, it was found that when the particle diameter of the particle diameter-controlling additive was too large or too small, the control effects of the additive were small. When the particle diameter of the particle diameter-controlling additive fell in the range from 0.005 to 0.5 μm, the effects of controlling particle diameter were particularly excellent. On the other hand, when the particle diameter was outside of the above preferable range, the effects were exhibited, but not comparing with those in the case of the above preferable range. In particular, it was found that the particle diameter-controlling additive of a particle diameter from 0.05 to 0.2 μm had the remarkable effects. Specifically, it is understood that the voltage required to obtain the same luminance can be reduced greatly, when the particle diameter of the additive is in the range from 0.05 to 0.2 μm.

### Example 11

To 150 g of a high-purity zinc sulfide powder, was added 2.0 g of copper acetate hydrate, followed by adding, as fluxes, 10 g of magnesium chloride, 0.5 g of barium chloride, and 10 g of sodium chloride, to mix them. To the resultant mixture, was added magnesium oxide (average particle diameter 0.1 μm) in an amount of 13 mass %, as a particle diameter-controlling additive, to mix. The resultant mixture was then placed in a crucible, and baked at 1200° C. for 6 hours. Then, the baked product was washed with deionized water several times, and further 1.0-mol/l hydrochloric acid was added thereto, to carry out dispersing, sedimentation and removal of the supernatant repeatedly, followed by drying, to give an intermediate phosphor.

Then, the intermediate phosphor was pulverized and dispersed in a ball mill. The pulverized powder was again placed in an alumina crucible, and baked at 700° C. for 2 hours. At that time, the baking was carried out with flowing 10% hydrogen sulfide gas as the atmosphere.

The particles after baking were pulverized again, and dispersed in 40° C. water and subjected to sedimentation, followed by removing the supernatant of the dispersion, and then unnecessary salts were removed therefrom, followed by drying. Further, a 10% KCN solution was heated to 70° C., and the solution was utilized to remove Cu ions and the like from the surface of the phosphor particle.

Using the thus-obtained phosphor, an electroluminescence device was produced in the same manner as in Example 1.

### Comparative Example 3

A phosphor was produced in the same manner as in Example 1, except that magnesium oxide was not added. Except for using the thus-obtained phosphor, an electroluminescence device was produced in the same manner as in Example 1.

The products obtained in Example 11 and Comparative Example 3 were tested and evaluated in the same manner as in Example 1. The results obtained are shown in Table 4. Further, the coefficient of variation in average circle equivalent diameter is shown together. The reduction in voltage is designated as the difference from the voltage in Comparative Example 3 that is assumed to be a standard.

TABLE 4

| | | | Average | | |
|---|---|---|---|---|---|
| | | | circle | Variation | |
| | Particle diameter- | | equivalent | coefficient | |
| | controlling additive | | diameter | of circle | |
| | | Particle | of the | equivalent | Reduction |
| | | diameter | phosphor | diameter | in voltage |
| | Kind | (μm) | (μm) | (%) | (V) |
| Example | Magnesium | 0.1 | 14 | 33 | 11 |
| 11 | oxide | | | | |
| Com- | — | — | 26 | 56 | Standard |
| parative | | | | | |
| example 3 | | | | | |

As is apparent from Table 4, the particle diameter of the phosphor is reduced and the coefficient of variation in the diameter can also be reduced, when magnesium oxide is added as the particle diameter-controlling additive. This ensures reduction in the layer thickness of the light-emitting layer and also ensures the smoothness of the layer surface in the device, thereby the voltage required to obtain the same luminance can be dropped greatly.

### Example 12

As a ZnS raw material, ZnS with 20 nm of crystallite size and 2 μm of mean particle size was provided. After 150 g of the ZnS was weighed, it was placed in a beaker of 3,000 ml volume, together with 2,000 ml of distilled water. The resultant mixture was stirred using a magnetic stirrer, to disperse all of the ZnS particles. Separately, 0.064 g of CuSO₄.5H₂O was weighed and dissolved in 2 ml of distilled water, to prepare a solution. The solution was added, through a bullet over about 30 seconds, to the above solution in which ZnS particles were dispersed. After the completion of addition, the resultant mixture was stirred for 30 minutes. Then, the stirring was stopped, and the mixture was left stood until the ZnS particles sedimented completely. Then, after the supernatant was removed therefrom by decantation, 2,000 ml of distilled water was added to wash the precipitate, and the resultant mixture was stirred again, to give a dispersion. After the dispersion was stirred for 10 minutes, ZnS particles were subjected to sedimentation, and the supernatant thereof was removed away by decantation. This washing process was repeated 3 times, and then the finally-obtained precipitate was dried with a hot-wind dryer at 120° C. for 4 hours, to give Cu-added ZnS.

To the thus-obtained Cu-added ZnS, the following fluxes and additive were added, followed by mixing them in a mortar, to give a mixture.

| | |
|---|---|
| Cu-added ZnS | 150 g |
| Sodium chloride | 4.0 g |
| Barium chloride dihydrate | 8.0 g |
| Magnesium chloride hexahydrate | 16.8 g |
| Magnesium oxide (0.05 μm) | 20 g |

After an alumina crucible was filled with the thus-obtained mixture, the cap of the crucible was closed, and the crucible was set in a muffle furnace of room temperature. The muffle furnace was heated to and maintained at 1,200° C., and a first baking was carried out in the air for 4 hours. After completion of the first baking, the muffle furnace was left stood and cooled to room temperature, and then the first-baked mixture product was taken out from the alumina crucible. The first-baked product was washed with 4,000 ml of 1.0M HCl aqueous solution, and then with 400 ml of distilled water 5 times, followed by drying at 120° C. for 4 hours, to give a ZnS:Cu,Cl intermediate phosphor particle.

Then, the thus-obtained intermediate phosphor particle was pulverized and dispersed in a ball mill, and the alumina crucible was filled with the resultant particle, again. The cap of the crucible was closed, and the crucible was set in a muffle furnace of room temperature. The muffle furnace was heated to and maintained at 700° C., and a second baking was carried out in the air for 4 hours. After completion of the second baking, the muffle furnace was cooled to room temperature, and then the second-baked product was taken out from the alumina crucible. The resultant second-baked product was washed with 100 ml of 10% KCN aqueous solution, and then with 500 ml of distilled water 5 times, followed by drying at 120° C. for 4 hours, to give a ZnS:Cu,Cl EL phosphor particle.

### Example 13

An EL phosphor particle was prepared in the same manner as in Example 12, except that 0.0424 g of aurichloride tetrahydrate was added to the Cu-added ZnS in Example 12, in addition to the above fluxes, to carry out the baking.

### Example 14

An EL phosphor particle was prepared in the same manner as in Example 12, except that the baking was carried out with 0.24 g of antimony trichloride added to the intermediate phosphor particle in Example 12.

### Example 15

An EL phosphor particle was prepared in the same manner as in Example 12, except that the baking was carried out with 0.32 g of bismuth trichloride added to the intermediate phosphor particle in Example 12.

### Example 16

An EL phosphor particle was prepared in the same manner as in Example 12, except that 36.0 g of cesium chloride was added to the Cu-added ZnS in Example 12, in addition to the above fluxes, to carry out the baking.

### Comparative Example 4

An EL phosphor particle was prepared in the same manner as in Example 12, except that magnesium oxide was not added at all.

Using the EL phosphor (particles) obtained in Examples 12 to 16 and Comparative example 4, EL devices were prepared in the same manner as in Example 1, respectively. The average circle equivalent diameter (average of 500 particles observed by SEM) each of the thus-obtained phosphor particles, was measured. Further, the luminance half time of each of the EL devices when 180 V of sine wave alternating voltage was applied to each of the EL devices to drive so that the luminescence would become 600 cd/m² by adjusting the frequency, was measured. The results are shown in Table 5.

TABLE 5

| | | | | | Lumi- |
|---|---|---|---|---|---|
| | | | | Average | nance |
| | Particle diameter- | | Metal | circle | half time |
| | controlling additive | | element | equivalent | with initial |
| | | Particle | contained | diameter | luminance |
| | | di- | in the | of the | of |
| | | ameter | compound | phosphor | 600 cd/m² |
| | Kind | (μm) | added | (μm) | (hr) |
| Example 12 | Magnesium | 0.05 | — | 12 | 360 |
| | oxide | | | | |
| Example 13 | Magnesium | ″ | Au | 12 | 690 |
| | oxide | | | | |
| Example 14 | Magnesium | ″ | Sb | 13 | 580 |
| | oxide | | | | |
| Example 15 | Magnesium | ″ | Bi | 12 | 570 |
| | oxide | | | | |
| Example 16 | Magnesium | ″ | Cs | 12 | 450 |
| | oxide | | | | |
| Comparative | — | — | — | 27 | 180 |
| example 4 | | | | | |

Note:
“—” means not added

As is apparent from Table 5, it is possible to remarkably improve the luminance half time at the initial luminance of 600 cd/m², as well as to make the phosphor particle size quite small, by adding the particle diameter-controlling additive. Further, it is possible to further improve the life of the EL device, by adding the compound containing such an element as Au, Sb, Bi or Cs.

Having described our invention as related to the present embodiments, it is our intention that the invention not be limited by any of the details of the description, unless otherwise specified, but rather be construed broadly within its spirit and scope as set out in the accompanying claims.

1. A method of producing an electroluminescence phosphor, comprising the steps of:
mixing a phosphor matrix, a flux, an activator, and a particle diameter-controlling additive that does not enter into a crystal lattice of said phosphor matrix, to give a mixture; and
baking the mixture, to produce the electroluminescence phosphor, said method comprising the step of: adding an acidic or alkaline solution, to remove the particle diameter-controlling additive from said phosphor.

2. The method of producing an electroluminescence phosphor according to claim 1, wherein a residual rate of the particle diameter-controlling additive is 5% or less.

3. The method of producing an electroluminescence phosphor according to claim 1, wherein the particle diameter-controlling additive has a particle diameter of 0.005 to 0.5 μm.

4. The method of producing an electroluminescence phosphor according to claim 1, wherein the particle diameter-controlling additive is a compound containing at least one of alkali earth metal oxides.

5. The method of producing an electroluminescence phosphor according to claim 1, wherein the particle diameter-controlling additive is magnesium oxide.

6. An electroluminescence phosphor, which is produced by the method of producing an electroluminescence phosphor according to claim 1, wherein the phosphor matrix has zinc sulfide, and wherein the phosphor has an average circle equivalent diameter of less than 20 μm.

7. The electroluminescence phosphor according to claim 6, wherein a coefficient of variation in the average circle equivalent diameter among particles of said phosphor is less than 40%.

8. The electroluminescence phosphor according to claim 6, which contains, as an additive, a compound containing at least one element selected from the group consisting of Au, Sb, Bi and Cs.

9. An electroluminescence device, comprising the electroluminescence phosphor according to claim 6.

10. An electroluminescence device, comprising the electroluminescence phosphor according to claim 7.

11. An electroluminescence device, comprising the electroluminescence phosphor according to claim 8.

12. The electroluminescence phosphor according to claim 6, wherein a residual rate of the particle diameter-controlling additive is 5% or less.

13. The electroluminescence phosphor according to claim 6, wherein the particle diameter-controlling additive has a particle diameter of 0.005 to 0.5 μm.

14. The electroluminescence phosphor according to claim 6, wherein the particle diameter-controlling additive is a compound containing at least one of alkali earth metal oxides.

15. The electroluminescence phosphor according to claim 6, wherein the particle diameter-controlling additive is magnesium oxide.

16. The electroluminescence device according to claim 9, wherein a residual rate of the particle diameter-controlling additive is 5% or less.

17. The electroluminescence device according to claim 9, wherein the particle diameter-controlling additive has a particle diameter of 0.005 to 0.5 μm.

18. The electroluminescence device according to claim 9, wherein the particle diameter-controlling additive is a compound containing at least one of alkali earth metal oxides.

19. The electroluminescence device according to claim 9, wherein the particle diameter-controlling additive is magnesium oxide.
